(19) United States
(12) Patent Application Publication
(10) Pub. No.: US 2010/0037319 A1
(43) Pub. Date: Feb. 11, 2010

(54) TWO STAGE ACCESS CONTROL FOR INTELLIGENT STORAGE DEVICE

(75) Inventors: David J. Steeves, Seattle, WA (US); Cormac E. Herley, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/188,442

(22) Filed: Aug. 8, 2008

(51) Int. Cl. G06F 11/00

(52) U.S. Cl. 726/23

(57) ABSTRACT

Systems and methods that resist malicious attacks on an intelligent storage device via an access control component that supplies security at a dual layer of defense. Such dual layer defense encompasses both resistance to brute force (e.g., unauthorized users), and resistance to a replay attack (e.g., a malicious code residing on a machine that hosts the intelligent storage device.) Accordingly, an access control component includes an anti malicious user component and an anti malicious code component, which can resist malicious attacks from both a person and a host unit with a malicious code residing thereon.

### BACKGROUND

Increasing advances in computer technology (e.g., microprocessor speed, memory capacity, data transfer bandwidth, software functionality, and the like) have generally contributed to enhanced computer application in various industries. For example, mobile devices are becoming a pervasive and all encompassing device for communication, entertainment, commerce, and personal finance. Moreover, there currently exists an impetus by banking institutions and telecommunication companies to enable such mobile devices to fully perform on line transactions and/or function as a secured storage.

Common examples of these devices include personal information managers, personal digital assistants, palmtop computers, cellular telephones, and the like. Such devices typically include some type of data storage with associated functionality and data communication ability (e.g., address book or contact information storage, calendar and scheduling, and note taking) among others. More sophisticated devices can usually store and use multiple file types and choose from among multiple types of data connections. Typical types of data connections include wired connections such as universal serial bus (USB), IEEE 1394, or others and wireless connections such as code division multiple access (CDMA), time division multiple access (CDMA), global system for mobile communications (GSM), IEEE 802.11x, and Bluetooth.

Likewise, smart storage devices having electronic memories are becoming increasingly popular, and employed for facilitating transactions (e.g., security access, authenticated identification, sensitive information storage, financial transfers, and the like.) Generally, in order avoid misuse, a proprietary and centrally controlled system can be fielded with a card issuing authority that stores sensitive information on a smart card for subsequent use. Participating entities can then be provided with necessary access protocols, passwords, and the like, in order to use such cards.

Similarly, Universal Serial Bus (USB) drives have become a common means for users to roam their data. It is becoming increasingly desirable to store credentials on such devices. For example, rather than memorize all related passwords, a single unit can now serve as portable storage.

Accordingly, and as file systems on storage devices become more strategic and popular, new challenges can arise for efficient and proper maintenance of such systems. For example, if a user stores all credentials on a single smart storage device, then by accessing a relatively unimportant account, such as a free email, other sensitive information such as bank credentials can be at risk of exposure. Assuming a USB device stores all of users credentials and there is a single PIN to unlock the device, if unlocked all associated credentials are potentially accessible to malware running on a host machine. In addition, diverse sets of credential can require distinct levels of protection/different trust environments, and hence a different level of protection is desirable. Nonetheless, protecting different credential sets with individual PINs is becoming increasingly burdensome for the user.

Moreover, portable computing units are hosting such intelligent storage devices, and hence become custodian of sensitive personal information. Accordingly, securing against theft and hacking (e.g., engaging in illegal machine trespass, such as contravening computer security) has become of paramount importance. In addition, risk of data exposure can increase when the host portable computing units are further used in conjunction with other machines such as a desktop or laptop personal computer.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation resists malicious attacks on an intelligent storage device via an access control component that supplies security at a dual layer of defense; namely; resistance to brute force (e.g., unauthorized users), and resistance to a replay attack (e.g., a malicious code residing on a machine that hosts the intelligent storage device.) Accordingly, the access control component includes an anti malicious user component and an anti malicious code component, which can resist malicious attacks from both a person and another machine (e.g., a host machine), which has a malicious code residing thereon.

The intelligent storage device or unit can be in form of flash drives, Secure Digital (SD) cards, smart cards, hard drive with crypto processors, and the like. As such, the intelligent storage device can include a plurality of subsets (e.g., partitioned memory locations, which store identity credentials), wherein the anti malicious user component grants access to all subsets as a whole via an unlocking thereof, for a subsequent selection of each subset. Likewise, upon selection of a memory subset, the anti malicious code component can grant access by challenging the requester with a human interactive proof. Such can be in form of a challenge-response string (e.g., portions of a text string such as a movie quote/song)—which can be readily responded by a human, and yet not a code. Moreover, such challenge can pertain to a user's recognition of features in an image or personal photos previously designated by the user. It is to be appreciated that the challenge cannot be readily learned by a malware as the question can change (e.g., randomly) with respect to access for each segment. Put differently, the anti malicious code component supplies challenges that employ processes, which can be performed by a human and not by a computer (e.g., Completely Automated Public Turing test to tell Computers and Humans Apart—CAPTCHA, and human interactive proofs systems—HIPS.)

Hence, resources on the intelligent storage device are protected against both malicious codes and malicious users via such two layers of protection.

In a related aspect, the intelligent storage device can include a USB drive, with memory partitions assigned different security levels (e.g., high, medium, low). When such USB drive is employed in conjunction with a public host machine such as a computer (e.g., in an internet café), vulnerabilities associated with the public use such as theft of digital identity can be mitigated. Initially the USB can be unlocked via the anti malicious user component, thus passing a first hurdle of security regarding the authorized user. Likewise, regarding vulnerabilities arising from a machine code residing on the host unit, human interactive proofs are further added to the device for different containers (e.g., memory segments) thereof—which holds sensitive credentials. Put differently each of a set of human interactive proofs can correspond to a respective partitioned segment (e.g., memory location) of the USB—hence mitigating malicious code attacks. For example, a user can initially unlock the intelligent storage device, hence designating that an authorized user is present and operating with the system. Subsequently, if the intelligent storage device receives a request for accessing corporate e-mail accounts that is stored thereon—then a grid of pictures can be presented wherein the system asks the user to click on the picture that belongs to such user (or click on the picture with a identifiable human trait such as being happy), wherein a computer cannot do such—even if a malware captures the interaction once, it cannot repeat the task performed, since the next challenge is not the same as the first challenge.

According to a particular methodology of the subject innovation, initially a user of the intelligent storage unit operatively connects (e.g., plugs in) to a host machine (e.g., a public PC in an internet café.) Subsequently, the intelligent storage unit can challenge the user for authentication (e.g., through a user input on the device or a computer.) Accordingly, verification is performed regarding presence of a human authorized user (e.g., presence of the intelligent storage unit owner.) Subsequently, a request is received by the intelligent storage unit for access to a digital credential stored therein—(e.g., subsets/partitions of a storage medium in the intelligent storage unit). Next, the intelligent storage unit can challenge the user with a human interactive proof.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an intelligent storage unit that implements a dual layer of defense for protection according to an aspect of the subject innovation.

FIG. 2 illustrates a particular aspect of an anti-malicious user component according to a further aspect of the subject innovation.

FIG. 3 illustrates a further aspect of an anti-malicious code component in accordance with a particular aspect of the subject innovation.

FIG. 4 illustrates an exemplary user-interface that employs a maze-type configuration as part of a dual layer of defense according to an aspect of the subject innovation.

FIG. 5 illustrates a further aspect of an intelligent storage unit, which can include a plurality of subsets such as partitioned memory locations that store identity credentials, wherein the anti malicious user component grants access to all subsets as a whole via unlocking thereof.

FIG. 6 illustrates a methodology of resisting a malicious attack according to an exemplary aspect of the subject innovation.

FIG. 7 illustrates a further methodology of protecting resources on an intelligent storage unit according to a particular aspect of the subject innovation.

FIG. 8 illustrates an intelligent storage unit with a dual defense layer that can further include an artificial intelligence component according to an aspect of the subject innovation.

FIG. 9 is a schematic block diagram of a sample-computing environment that can be employed as part of, or in association with an intelligent storage unit in accordance with an aspect of the subject innovation.

FIG. 10 illustrates an exemplary environment for implementing various aspects of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

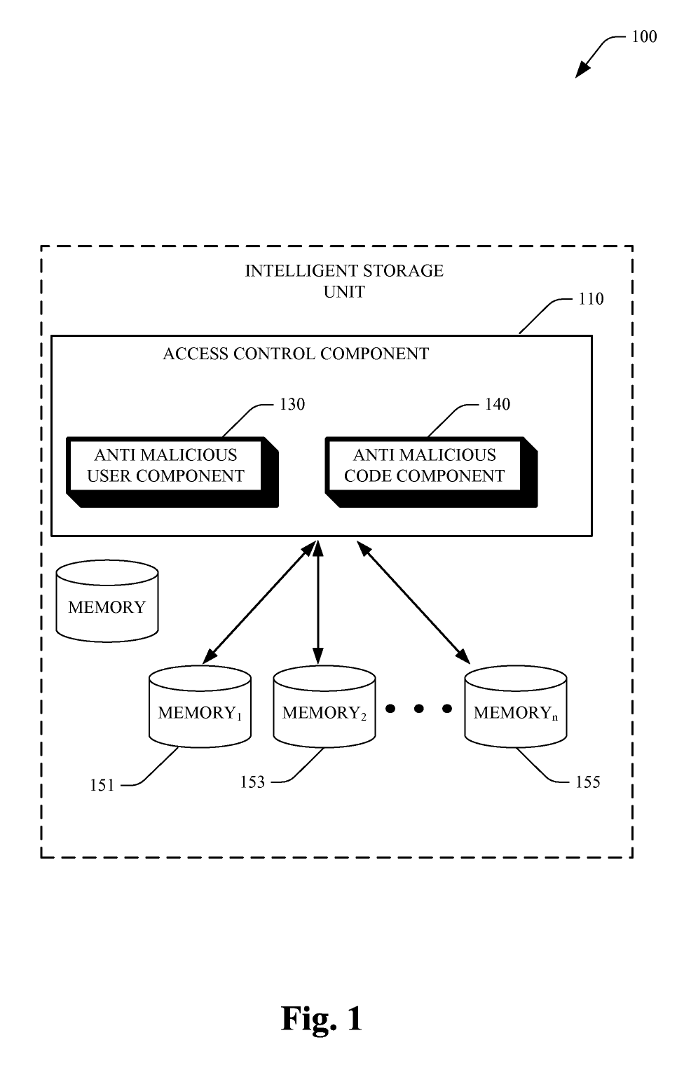

FIG. 1 illustrates an intelligent storage unit 100 that includes an access control component 110 to supply dual layer of defense; namely; resistance to brute force (e.g., unauthorized users), and resistance to a replay attack (e.g., a malicious code residing on a machine that hosts the intelligent storage unit.) The intelligent storage unit 100 can be in form of flash drives, Secure Digital (SD) cards, smart cards, hard drive with crypto processors, and the like.

The access control component 110 further includes an anti malicious user component 130 and an anti malicious code component 140, which can resist malicious attacks from both a person and an external unit (e.g., which can host the intelligent storage unit) with a malicious code residing thereon. The intelligent storage unit 100 can store user data/sensitive information in any/all plurality of memory segments 151, 153, 155 (1 to n, n being an integer), wherein such information can for example include; user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, and the like.

Likewise, each of the memory segments 151, 153, 155 can encompass volatile memory or non-volatile memory, or can include both volatile and non-volatile memory. Such non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM).

In addition, the intelligent storage unit 100 can include a plurality of subsets (e.g., partitioned memory locations that store identity credentials), wherein the anti malicious user component 130 grants access to all subsets as a whole via unlocking thereof, for a subsequent selection of each subset. Likewise, upon selection of a memory subset the anti malicious code component 140 can grant access by challenging the requestor with a human interactive proof. Such can be in form of a challenge-response string (e.g., portions of a text string such as a movie quote/song)—which can be readily responded by a human and not a code. Moreover, such challenge can pertain to a user's recognition of features in an image or personal photos previously designated by the user. It is to be appreciated that the challenge cannot be readily learned by a malware as the question can change (e.g., randomly) with respect to access for each segment. Put differently, the anti malicious code component 140 supplies challenges that employ processes, which can be performed by a human and not by a computer (e.g., GIF representations—and hence presence of a human can be verified. Hence, resources on the intelligent storage unit 100 are protected against both malicious codes and malicious users via such two layers of protection.

Moreover, the intelligent storage unit 100 can be hosted by, and/or operatively connected to an other machine(s). For example, the intelligent storage unit 100 can be inform of USB device classes, portable hard drives, flash memory devices, cared readers, which can be hosted by personal data assistants, mobile devices, pocket PC, a smart phone, and the like

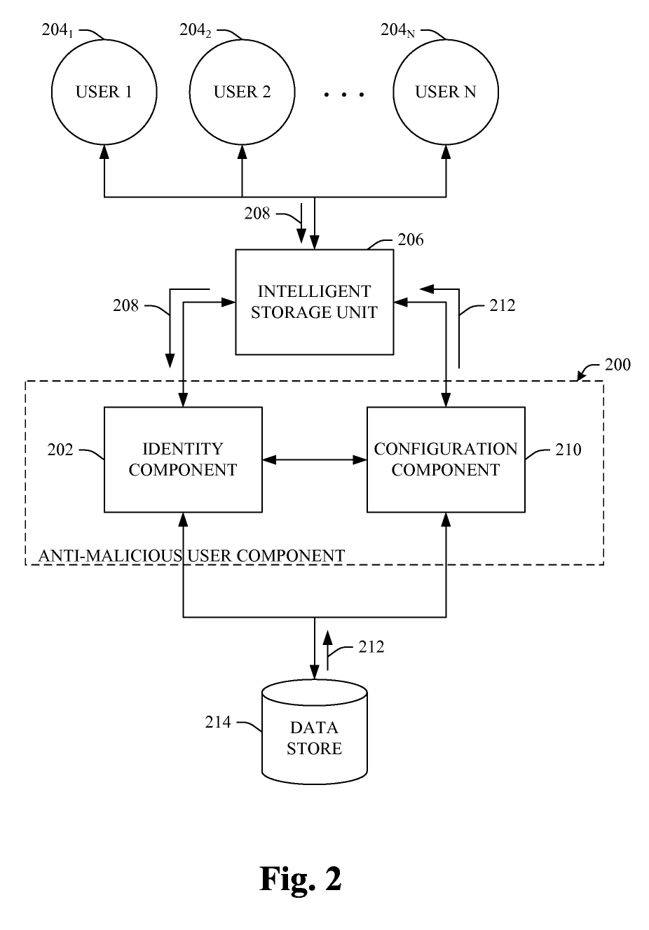

FIG. 2 illustrates a particular anti malicious user component 200 as part of a dual stage protection of data in an intelligent storage unit 206 according to a particular aspect of the subject innovation. The anti malicious user component 200 can configure the intelligent storage unit 206 based upon identity detection. As illustrated in FIG. 2, the system 200 can include an identity component 202 that can determine an identity of a user 204₁-204_{N}, to filter unauthorized users from authorized ones. As such, the identity component 202 can determine the identity of a current user based upon verifiable identification input 208 associated with such user. Typically, the verifiable identification input can require a volitional act on behalf of the user—or alternatively can be performed automatically. For example, the verifiable identification input 208 can be user biometrics.

In order to determine the identity of the user, the identity component 202 can, access a data store 214, wherein such data store 214 can include templates previously collected, inferred, defined, or established that relate to the verifiable identification input 208. Thus, according to one aspect of the subject innovation, the identity component 202 can match newly received verifiable identification input 208 to templates stored in the data store 214. In addition, the identity component 202 can update or manage templates as well as create new templates (e.g., a template for a new user) as verifiable identification input 208 is received. It is to be appreciated that the verifiable identification input 208 need not be received directly from a user, but can also be obtained by the intelligent storage (e.g., a hand scan while the user picks up the intelligent storage unit).

The anti-malicious component 200 can also include a configuration component 210 that can retrieve settings 212 associated with the user of the intelligent storage unit 206. In addition, the configuration component 210 can apply the settings 212 to the intelligent storage unit 206. For example, the configuration component 210 can be operatively connected to the identity component 202. Thus, once the identity component 202 determines the identity of the authorized user the configuration component 210 can, access the data store 214 to retrieve the settings 212 associated with such user and automatically configure the intelligent storage unit 206 in accordance with such settings 212. The configuration component 210 can configure the device 206 in a variety of formats such as based upon, type of intelligent storage unit 206, nature of the settings 212 associated with current user, and the like. For example, the configuration component 210 can apply the settings 212 to the intelligent storage unit 206 based upon whether another machine hosting such intelligent storage unit 206 is a handheld electronic device, an I/O peripheral, or a controller that controls peripherals or aspects of one or more devices. Accordingly, the configuration component 210 can apply settings 212 that affect a physical configuration of the host machine (e.g., format of data display) as well as a data set employed by the host machine.

It is to be further appreciated that the identity component 202 can include an input component (not shown) that is configured to receive the verifiable identification input 208. For example, the input component can be reader, scanner, detector, sensor, or some other suitable component that can obtain a biometric from the user 204. Such input component can be specifically tailored for the intelligent storage unit 206 and/or a machine that hosts the intelligent storage unit such that a particular type of biometric can be readily obtained. For example, if a machine that hosts the intelligent storage unit 206 is a handheld electronic device, such host can be particularly well suited to readily obtain biometrics related to a user's hands, e.g., fingerprint, hand geometry, grip configuration, and the like—whereas an earpiece can be better suited to obtain a different type of biometric such as a biometric relating to a user's earlobe, for example).

Moreover, the biometric data employed can be associated with a wide variety of categorizations, such as universality, uniqueness, permanence, collectability, performance, acceptability, circumvention, and the like. For example, universality generally relates to the commonality of the biometric, e.g., how commonly such biometric exists in users. Likewise, uniqueness relates to how distinguishing the biometric is between various users. Similarly, permanence is a metric that measures how well the biometric withstands change, such as repetition, growth, aging, and the like. Moreover, collectability indicates the ease with which the biometric can be obtained for storage, analysis, or the like. In addition, performance defines the accuracy, speed, or robustness of obtaining and/or utilizing such biometric. Acceptability relates to the level or degree of consent or approval with respect to utilizing the biometric. Likewise, circumvention measures the difficulty of generating fraudulent or counterfeit biometric data.

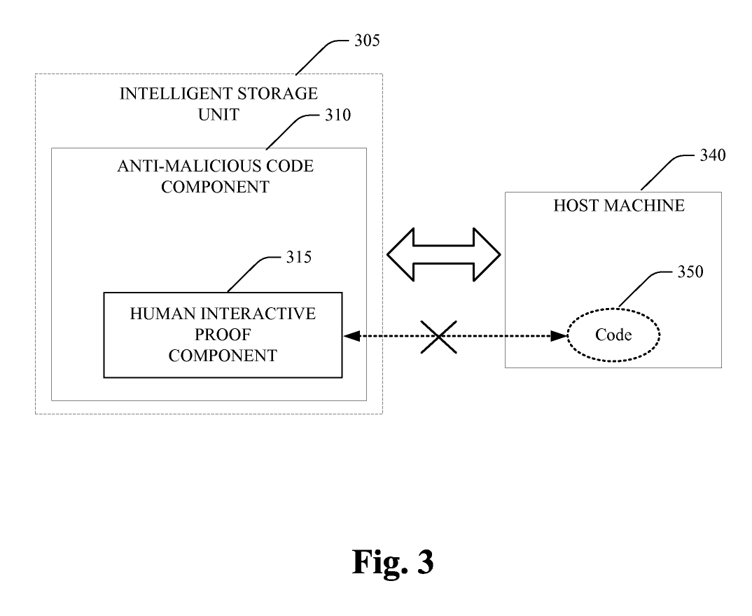

FIG. 3 illustrates an anti malicious code component 310, which can grant access by challenging the requestor—such as a code 350 (e.g., malicious code) with a human interactive proof. The code 350 can reside in a machine 340 that hosts the intelligent storage unit and/or is operatively connected thereto. The human interactive proof component 315 can be in form of a challenge-response string (e.g., portions of a text string such as a movie quote/song)—which can be readily responded by a human, and yet not by a malicious code. Moreover, such challenge can pertain to a user's recognition of features in an image or personal photos previously designated by the user. It is to be appreciated that the challenge cannot be readily learned by the code 350 as the question can change (e.g., randomly) with respect to access for each segment such as a memory partition of the intelligent storage unit 305. Put differently, the anti malicious code component 310 supplies challenges that employ processes, which can be performed by a human and not by a computer (e.g., GIF representations—and hence presence of a human can be verified.

For example, a human interactive proof (HIP) employed by the anti-malicious code component 310 can be in form of relatively simple puzzles, which are solvable by humans. One such HIP can be an image of a letter sequence that has been distorted to be difficult for an OCR (Optical Character Recognition) system to recognize, yet that is still discernable a human being. Such HIPs can require identification of each element in an image or a correct answer to a sequence of questions, for example. Other aspects of the HIPs implemented by the human interactive proof component 315 can ask users to repeat a sequence provided in a distorted manner (e.g., audio and/or video form).

For example, a common sequence-based HIP employed by the human interactive proof component 315 can include:
6K C P T R X 8

When presented with the above HIP, a user is instructed to key in the characters in the above sequence, via an interface of the host machine 340. This type of sequence-based HIP is an image of a letter-number sequence that has been distorted to be difficult for OCR software to recognize—yet easy enough for a human to transcribe (e.g., 6-K-C-P-T-R-X-8). The human interactive proof component 315 can be dynamically updated with new challenges, to address cases wherein if wrong answers are frequently received for any given instance of a HIP (of any type, order-based or otherwise) then the HIP is deemed too difficult for even humans to solve and thus ineffective in blocking only the code 350 from access. Hence, as new HIPs are being generated, a determination can also be made as to their difficulty and ultimately as to their effectiveness for protection against non-human access.

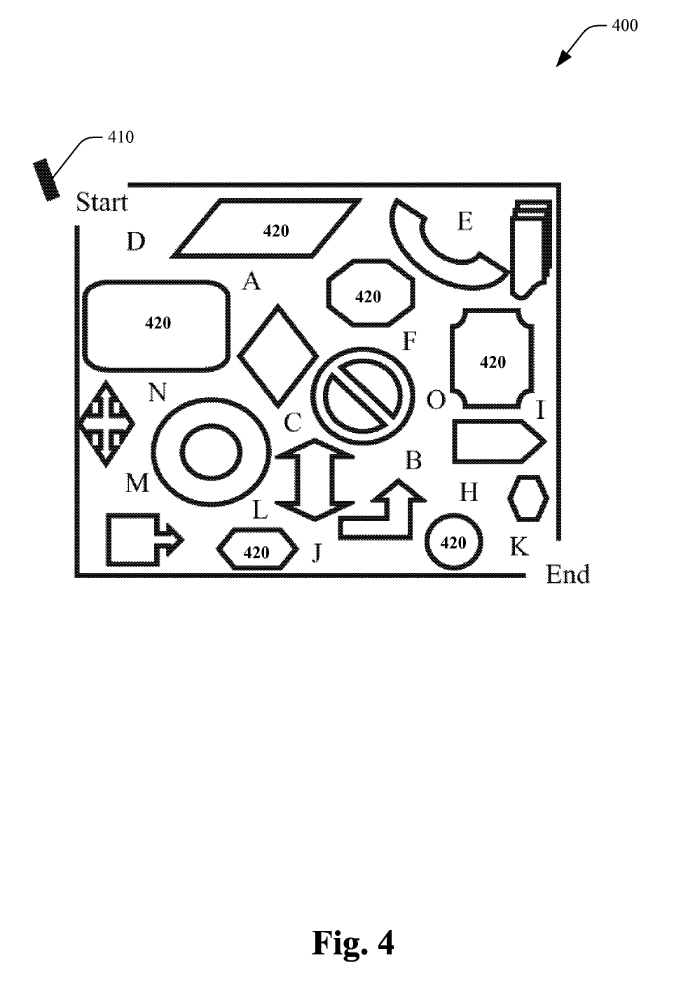

FIG. 4 illustrates a user-interface of yet another exemplary order-based HIP 400 that employs of a maze-type configuration, which can be employed to mitigate attacks on an intelligent storage unit through a dual layer of defense. Such a maze can be designed so that it is difficult for computers, but not too difficult for humans to solve. The objective is to maneuver the rectangular block 410 from the START to the END positions, by keying order of letters in a correct path. The maze HIP 400 requires rotations, contortions, as well as other visualizations that are relatively difficult for a computer to perform. Such is due in part by the employment of an odd-shaped object being maneuvered through the maze (e.g., as opposed to a round ball which is relatively easy to maneuver through a maze).

Furthermore, the rectangular block 410 should travel through and in between other odd-shaped objects and/or images 420. Hence, solving the maze HIP requires some minimum amount of knowledge about the block 410 and/or the images 420 in order to perform the necessary visualizations, for example. Moreover size and types of images included in the maze can vary to make it more cost-prohibitive to write HIP solving software.

In addition, the difficulty of maze HIPs can be further increased by forming a three-dimensional display of the maze to be solved and/or by incorporating pictures or images of real objects, some of which can serve as severe impediments to the rectangular block 410.

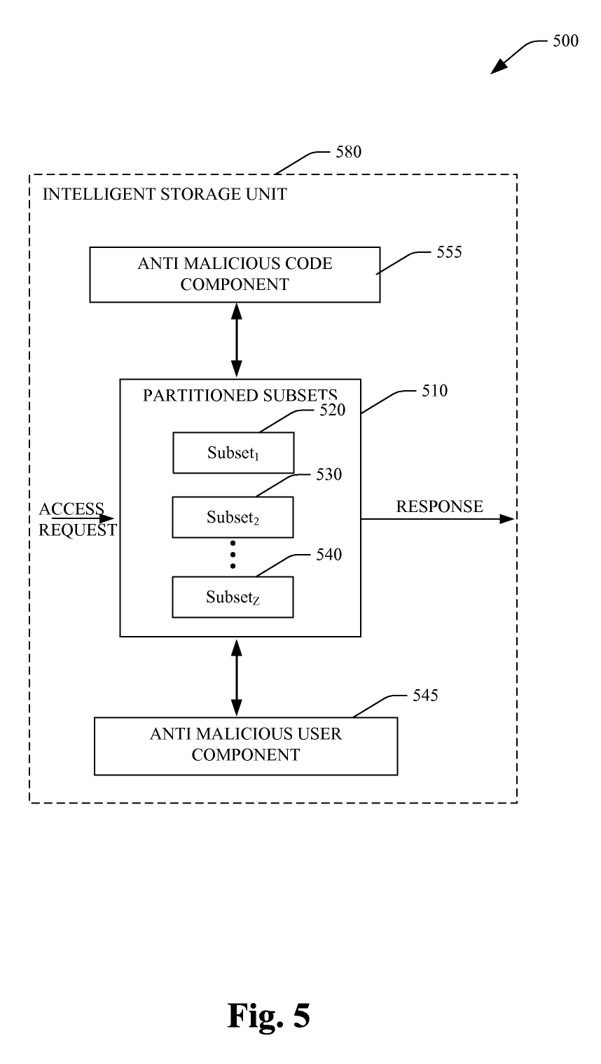

FIG. 5 illustrates a further aspect of an intelligent storage unit 580, which can include a plurality of subsets 520, 530, 540, such as partitioned memory locations that store identity credentials, wherein the anti malicious user component 545 grants access to all subsets 520, 530, 540 as a whole via unlocking thereof. A request for subsequent access to each of the subsets 520, 530, 540 can then be scrutinized via the anti-malicious code component 555 of the subject innovation. Likewise, upon selection of a memory subset the anti malicious code component 555 can grant access by challenging the requester with a human interactive proof via the HIP component (not shown). The partitioned subsets 510 can further be dynamically updated based on user response.

For example, the intelligent storage unit 580 can be in form of a USB drive, with the partitioned subsets 520, 530, 540 being memory partitions that are assigned different security levels (e.g., high, medium, low). When such USB drive is employed in conjunction with a public computer (e.g., in an internet café) vulnerabilities associated with the public use such as theft of digital identity can be mitigated. Initially the USB can be unlocked via the anti malicious user component, thus passing a first hurdle of security regarding the authorized user. Likewise, regarding vulnerabilities arising from a machine code residing on the host unit, human interactive proofs are further added for different containers (e.g., memory segments) thereof—which holds sensitive credentials. Put differently, each of a set of human interactive proofs can correspond to a respective partitioned segment (e.g., memory location) of the USB—hence mitigating malicious code attacks. For example, a user can initially unlock the intelligent storage unit 580, hence designating that an authorized user is present and operating with the system. Subsequently, if the intelligent storage unit 580 receives a request for accessing corporate e-mail accounts that is stored on such intelligent storage unit 580—then a grid of pictures can be presented wherein the system asks the user to click on the picture that belong to such user (or click on the picture with a identifiable human trait such as being happy; wherein a computer cannot do such—even if a malware captures such interaction once—it cannot repeat the task performed since the next challenge is not the same as the first challenge.

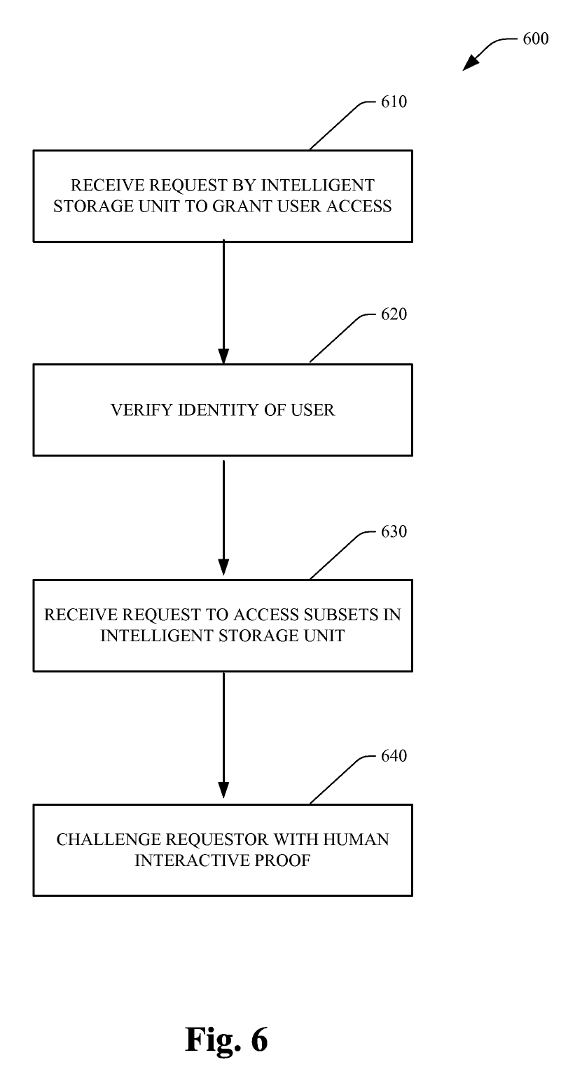

FIG. 6 illustrates a further methodology 600 of resisting brute force attacks and replay attacks on an in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and at 610 the intelligent storage unit can receive request to grant access to a user. To grant such access, the intelligent storage unit initially verifies identity of the user and supplies resistance to brute force (e.g., unauthorized users) at 620. Such verification supplies access to all subsets as a whole—which is subsequently followed by a request at 630 for selection of a particular subset. The intelligent storage unit then challenges the user with human interactive proof at 640 to supply resistance to a replay attack (e.g., a malicious code residing on a machine that hosts the intelligent storage unit.)

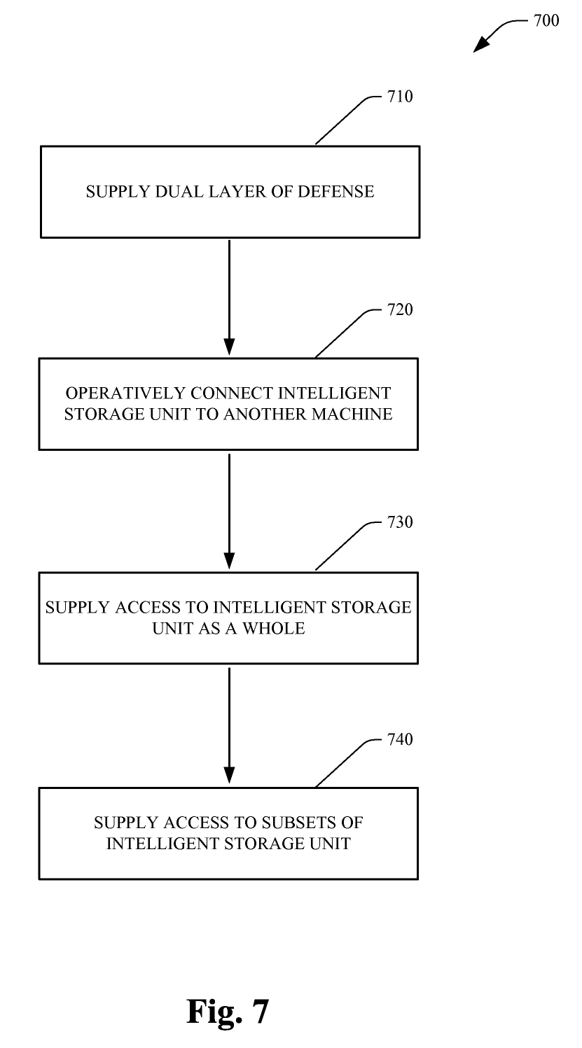

FIG. 7 illustrates a related methodology 700 of resisting malicious codes on an intelligent storage unit when such device is operatively connected to another machine, according to a further aspect of the subject innovation. Initially and at 710 a dual layer of defense is supplied for the intelligent storage unit, namely; resistance to brute force (e.g., unauthorized users), and resistance to a replay attack (e.g., a malicious code residing on a machine that hosts the intelligent storage unit.) Subsequently and at 720, the user of the intelligent storage unit operatively connects (e.g., plugs in) such intelligent storage unit to a host machine (e.g., a public PC in an internet café.) Subsequently, the intelligent storage unit can challenge the user for authentication (e.g., through a user input on a host machine), to supply access to the intelligent storage unit as a whole at 730—such as by an unlocking of the intelligent storage unit. Upon verification for such user, access can be supplied at 740 to subsets of the intelligent storage unit, such as different containers (e.g., memory segments) thereof—which holds sensitive credentials.

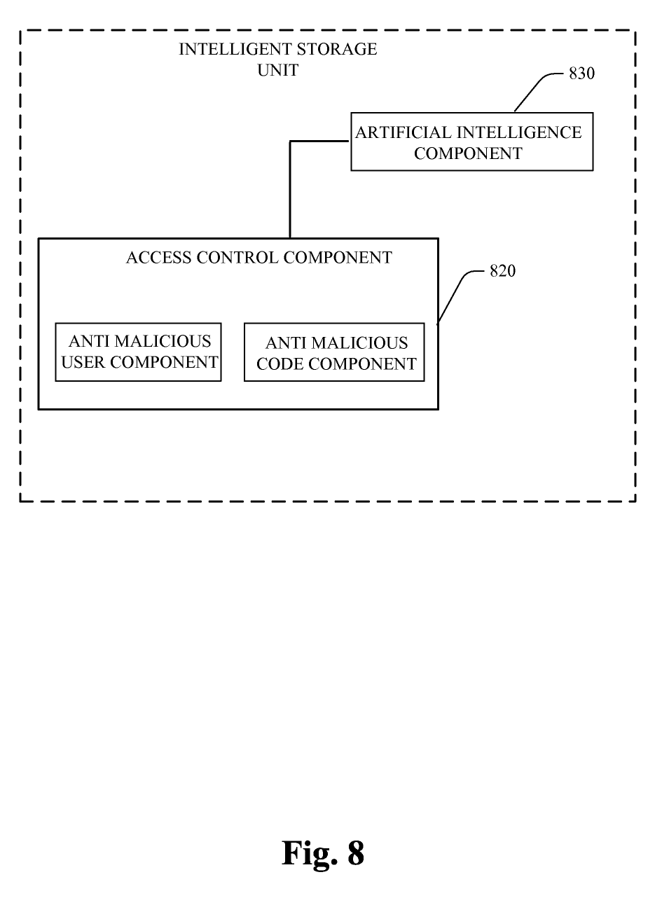

FIG. 8 illustrates an artificial intelligence component 830 that interacts with an access control component 820 according to an aspect of the subject innovation. Such artificial intelligence component 830 can be employed to facilitate inferring and/or determining when, where, how to challenge a user regarding verification processes in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 830 can employ any of a variety of suitable AI-based schemes as described supra in connection with facilitating various aspects of the herein described invention. For example, a process for learning explicitly or implicitly how a user should be notified upon receipt of a message can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

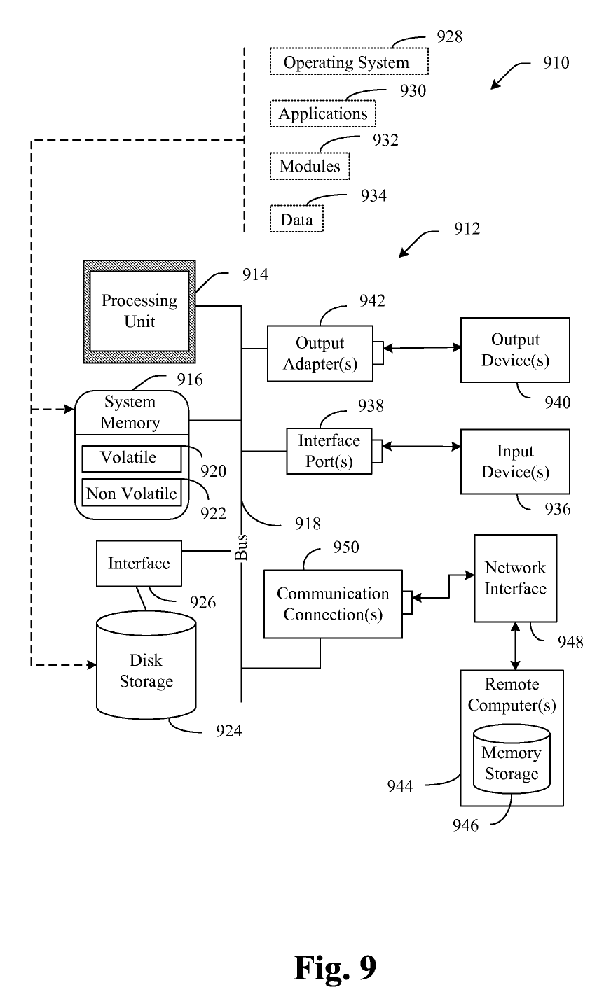

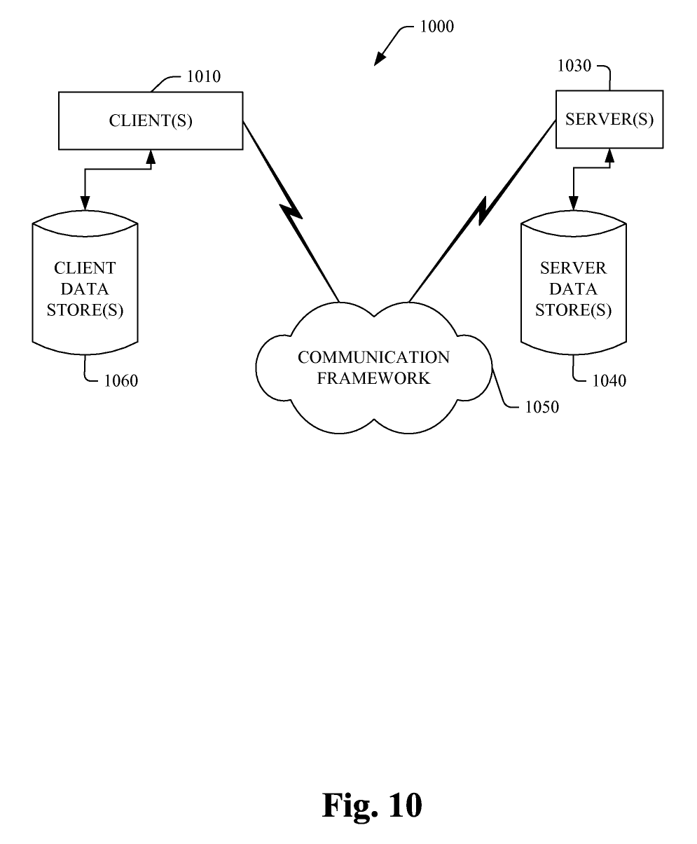

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a dual security in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
an intelligent storage unit; and
an access control component as part of the intelligent storage unit to provide access thereto, the access control component further comprises an anti malicious user component that resists brute force and an anti malicious code component that resists replay attacks by a code.

2. The computer implemented system of claim 1, the intelligent storage unit further comprising partitioned subsets for storage of data.

3. The computer implemented system of claim 1, the intelligent storage unit positionable within a host machine for interaction therewith.

4. The computer implemented system of claim 1, the anti malicious user component further comprising an identity component that determines identity of a user.

5. The computer implemented system of claim 4, the anti malicious user component further comprising a configuration component that applies settings associated with an authorized user to the intelligent storage unit.

6. The computer implemented system of claim 4, the anti malicious code component further comprising a human interactive proof component.

7. The computer implemented system of claim 6, the intelligent storage unit component with a user interface that employs a challenge-response string.

8. The computer implemented system of claim 1, the intelligent storage unit is a USB type device, or a secure digital card, or a smart card, or a hard drive with crypto processor.

9. The computer implemented system of claim 1, the intelligent storage unit further comprising an artificial intelligence component that facilitates verification of a user.

10. A computer implemented method comprising the following computer executable acts:
resisting both a brute force attack by unauthorized users and a replay attack by a code, to contents of an intelligent storage unit; and
interacting with the intelligent storage unit through a machine that is operatively connected thereto.

11. The computer implemented method of claim 10 further comprising hosting the intelligent storage unit by the machine.

12. The computer implemented method of claim 11 further comprising accessing contents in subsets of the intelligent storage unit upon proving human interaction.

13. The computer implemented method of claim 11 further comprising receiving identification from a user.

14. The computer implemented method of claim 11 further comprising assigning security levels to memory partitions of the intelligent storage unit.

15. The computer implemented method of claim 11 further comprising employing biometrics to unlock the intelligent storage unit.

16. The computer implemented method of claim 11 further comprising configuring the intelligent storage unit based on users settings.

17. The computer implemented method of claim 11 further comprising inferring challenges in form request-response to a user.

18. The computer implemented method of claim 11 further comprising plugging the intelligent storage unit into the machine.

19. The computer implemented method of claim 18 further comprising verifying presence of a human by supplying a user's personal photos for recognition thereof.

20. A computer implemented system comprising the following computer executable components:
means for resisting a brute force attack in an intelligent storage unit; and
means for resisting replay attacks by a code in the intelligent storage unit.
